(19) United States
(12) Patent Application Publication
(10) Pub. No.: US 2014/0186554 A1
(43) Pub. Date: Jul. 3, 2014

(54) ADHESIVE FOR POLARIZING PLATE, POLARIZING PLATE INCLUDING ADHESIVE LAYER, AND LIQUID CRYSTAL DISPLAY

(71) Applicant: CHEIL INDUSTRIES INC., Gumi-si (KR)

(72) Inventors: Ri Ra Jung, Uiwang-si (KR); In Cheon Han, Uiwang-si (KR)

(73) Assignee: CHEIL INDUSTRIES INC., Gumi-si (KR)

(21) Appl. No.: 14/141,266

(22) Filed: Dec. 26, 2013

(30) Foreign Application Priority Data
Dec. 28, 2012 (KR) 10-2012-0157621

(51) Int. Cl. C09J 133/00; G02F 1/1339; C09J 7/02

(52) U.S. Cl. CPC C09J 133/00; C09J 7/02; G02F 1/1339
USPC 428/1.55; 525/326.1; 428/354

(57) ABSTRACT

Disclosed are an adhesive for polarizing plates, a polarizing plate including an adhesive layer, and a liquid crystal display. The adhesive includes a (meth)acrylic copolymer, a curing agent, and a silane coupling agent, wherein the (meth)acrylic copolymer has an average molecular weight of at least 800,000 g/mol. The adhesive has a storage modulus ranging from approximately 8,000 Pa or more to less than approximately 27,000 Pa at 85° C. and at a frequency ranging from 10⁻³ rad/s to 10² rad/s after curing, and is configured to bond a protective film having a water vapor transmission rate (WVTR) of approximately 100 g/m²/day or less at 40° C. and 90% RH. The polarizing plate includes a polarizer, a first protective film on a top surface of the polarizer, a second protective film on a bottom surface of the polarizer, and an adhesive layer on a bottom surface of the second protective film.

### CROSS-REFERENCE TO RELATED APPLICATION

This application claims priority to and the benefit of Korean Patent Application No. 10-2012-0157621 filed in the Korean Intellectual Property Office on Dec. 28, 2012, the entire content of which is incorporated herein by reference.

### BACKGROUND

1. Field

Aspects of the present invention relate to an adhesive for polarizing plates, a polarizing plate including an adhesive layer, and a liquid crystal display including the polarizing plate and the adhesive layer.

2. Description of the Related Art

Polarizing plates are often used to control an oscillation direction of light to show display patterns of a liquid crystal display inside and outside a liquid crystal cell. Although liquid crystal displays were initially applied to small apparatuses during early development, recently, liquid crystal displays have been used in wide application ranges including notebook computers, liquid crystal monitors, liquid crystal color projectors, liquid crystal televisions, navigation systems for vehicles, personal phones, measurement instruments used indoors and outdoors, etc.

Generally, the polarizing plate of a liquid crystal display includes a polarizer and protective films stacked on both sides of the polarizer. Triacetyl cellulose (TAC) films have typically been used as the protective films. However, recently, due to price or optical properties of TAC films, numerous attempts have been made to develop protective films made from alternative materials as the protective film of the polarizing plate.

These alternate-material films are often less expensive and have more desirable optical properties than TAC films, however, since these alternate films tend to exhibit a low water vapor transmission rate, a polarizing plate including the film bonded thereto using a conventional adhesive used for TAC films can result in the formation of micro-bubbles and deterioration in durability when exposed to high temperatures.

### SUMMARY

Aspects of the present invention relate to an adhesive for polarizing plates, a polarizing plate including an adhesive layer, and a liquid crystal display including the polarizing plate and the adhesive layer.

In accordance with one aspect of the present invention, an adhesive includes a (meth)acrylic copolymer, a curing agent, and a silane coupling agent. The (meth)acrylic copolymer may have an average molecular weight of at least 800,000 g/mol, and the adhesive may have a storage modulus ranging from approximately 8,000 Pa or more to less than approximately 27,000 Pa at 85° C. and at a frequency ranging from 10⁻³ rad/s to 10² rad/s after curing, the adhesive being configured to bond a protective film of a polarizing plate having a water vapor transmission rate (WVTR) of approximately 100 g/m²/day or less at 40° C. and 90% RH.

The adhesive may be configured to bond a protective film having a water vapor transmission rate (WVTR) ranging from approximately 2 g/m²/day to approximately 60 g/m²/day.

The protective film may include at least one of a cyclic polyolefin, a poly(meth)acrylate, a polycarbonate, a polyester, a polyethersulfone, a polysulfone, a polyamide, a polyimide, a polyolefin, a polyarylate, a polyvinyl alcohol, a polyvinyl chloride, and a polyvinylidene chloride film.

The (meth)acrylic copolymer may have an average molecular weight ranging from approximately 800,000 g/mol to approximately 1,800,000 g/mol.

The (meth)acrylic copolymer may have a glass transition temperature ranging from approximately −40° C. to approximately −30° C.

The (meth)acrylic copolymer may include a copolymer of a monomer mixture comprising a hydroxyl group-containing (meth)acrylic monomer, an alkyl group-containing (meth)acrylic monomer, and a carboxylic acid group-containing (meth)acrylic monomer.

The curing agent may include at least one of an isocyanate, a carbodiimide, an epoxy, an aziridine, a melamine, an amine, an imide, and an amide curing agent.

The curing agent may include a mixture of an isocyanate curing agent and a carbodiimide curing agent, and the mixture may have a weight ratio of the isocyanate curing agent to the carbodiimide curing agent ranging from 2:1 to 30:1.

The curing agent may include approximately 0.5 parts by weight to approximately 5 parts by weight based on 100 parts by weight of the (meth)acrylic copolymer.

The silane coupling agent may be an epoxy moiety.

The silane coupling agent may include approximately 0.01 parts by weight to approximately 5 parts by weight based on 100 parts by weight of the (meth)acrylic copolymer.

According to another embodiment of the present invention, a polarizing plate includes a polarizer, a first protective film on a top surface the polarizer, a second protective film on a bottom surface of the polarizer, and an adhesive layer on at least a bottom surface of the second protective film, the adhesive layer having a (meth)acrylic copolymer, a curing agent, and a silane coupling agent. The (meth)acrylic copolymer may have an average molecular weight of at least 800,000 g/mol, and an adhesive of the adhesive layer may have a storage modulus ranging from approximately 8,000 Pa or more to less than approximately 27,000 Pa at 85° C. and at a frequency ranging from 10⁻³ rad/s to 10² rad/s after curing, the adhesive being configured to bond the protective film.

The adhesive layer and the first protective film may each have a water vapor transmission rate (WVTR) of approximately 100 g/m²/day or less at 40° C. and 90% RH.

The second protective film may have a water vapor transmission rate (WVTR) of approximately 100 g/m²/day or less at 40° C. and 90% RH, and may be configured to be coupled to a liquid crystal display panel via the adhesive layer.

The polarizing plate may further include a third protective film on a lower surface of the second protective film, at least one of the second and third protective films may have a water vapor transmission rate of approximately 100 g/m²/day or less at 40° C. and 90% RH, and the third protective film may be between the second protective film and a liquid crystal display panel via the adhesive layer.

According to another embodiment of the present invention, a liquid crystal display having a polarizing plate includes a polarizer, a first protective film on a top surface of the polarizer, a second protective film on a bottom surface of the polarizer, and an adhesive layer on at least a bottom surface of the second protective film, the adhesive layer having a (meth)acrylic copolymer, a curing agent, and a silane coupling agent. The (meth)acrylic copolymer may have an average molecular weight of at least 800,000 g/mol, and an adhesive of the adhesive layer may have a storage modulus ranging from approximately 8,000 Pa or more to less than approximately 27,000 Pa at 85° C. and at a frequency ranging from 10⁻³ rad/s to 10² rad/s after curing, the adhesive being configured to bond the protective film.

The adhesive layer and the first protective film may each have a water vapor transmission rate (WVTR) of approximately 100 g/m²/day or less at 40° C. and 90% RH.

The second protective film may have a water vapor transmission rate (WVTR) of approximately 100 g/m²/day or less at 40° C. and 90% RH, and may be configured to be coupled to the liquid crystal display panel via the adhesive layer.

The polarizing plate may further include a third protective film on a lower surface of the second protective film, at least one of the second and third protective films having a water vapor transmission rate (WVTR) of approximately 100 g/m²/day or less at 40° C. and 90% RH, the third protective film being between the second protective film and the liquid crystal display panel via the adhesive layer.

### BRIEF DESCRIPTION OF THE DRAWINGS

FIG. 1 is a cross-sectional view of a polarizing plate according to one embodiment of the present invention.

FIG. 2 is a cross-sectional view of a polarizing plate according to another embodiment of the present invention.

FIG. 3 is a cross-sectional view of a polarizing plate according to a further embodiment of the present invention.

### DETAILED DESCRIPTION

Hereinafter, one or more embodiments of the present invention will be described in detail with reference to the accompanying drawings. It should be understood that the present invention may be embodied in different ways and is not limited to the following embodiments. In the drawings, portions not relevant to the immediate description will be omitted for clarity. Like components will be denoted by like reference numerals throughout the specification. As used herein, terms such as “upper side” or “upper surface” and “lower side” or “lower surface” are defined with reference to the accompanying drawings. Thus, it will be understood that the term “upper side” or “upper surface” can be used interchangeably with the term “lower side” or “lower surface.” It will be understood that when a layer is referred to as being placed “on” another layer, the layer may be directly placed on the other layer, or an intervening layer or layers may also be present. On the other hand, when a layer is referred to as being “directly placed on” another layer, an intervening layer or layers is not present between those layers. The term “(meth)acrylate” may refer to acrylates and/or methacrylates.

Hereinafter, an adhesive for polarizing plates according to one embodiment of the present invention will be described in detail.

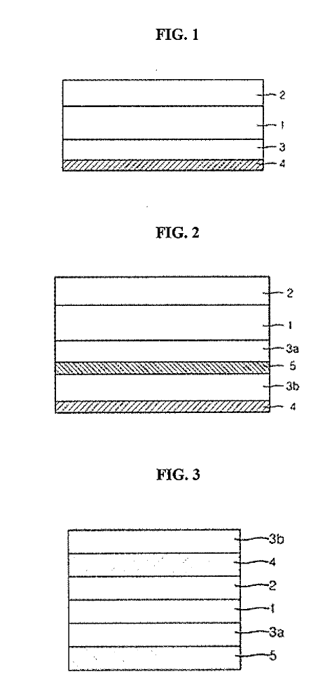

According to an embodiment of the invention, when a polarizing plate (as shown in FIGS. 1-3) includes a polarizer 1 and a protective film 2, 3, 3a, and/or 3b on a lower surface of the polarizer 1, wherein the protective film 2, 3, 3a, and/or 3b has a water vapor transmission rate of about 100 g/m²/day or less at 40° C. and 90% relative humidity (RH), an adhesive may be used to bond the polarizing plate to a liquid crystal display (LCD) panel or another protective film 2, 3, 3a, and/or 3b, the adhesive having a storage modulus ranging from approximately 8,000 Pa or more to less than approximately 27,000 Pa (Pascals) at 85° C. and at an angular velocity ranging from approximately 10⁻³ rad/s to approximately 10² rad/s, after curing. Specifically, the adhesive according to an embodiment may have a storage modulus ranging from approximately 8,000 Pa to approximately 26,000 Pa.

If the adhesive has a storage modulus of less than 8,000 Pa after curing, when a polarizing plate is prepared by bonding the protective film 2, 3, 3a, and/or 3b having a water vapor transmission rate of about 100 g/m²/day or less at 40° C. and 90% RH to the polarizer 1, the prepared polarizing plate can suffer from micro-bubbles when exposed to high temperature, and, thus, can exhibit poor external appearance. If a polarizing plate is prepared by bonding the protective film 2, 3, 3a, and/or 3b having a water vapor transmission rate of about 100 g/m²/day or less at 40° C. and 90% RH using the adhesive having a storage modulus of 27,000 Pa or greater after curing, the polarizing plate can suffer from deterioration and possible detachment between the layers.

The storage modulus according to embodiments of the present invention may be measured by any typical method. For example, an adhesive sheet, in which a cured product is manufactured by curing an adhesive for polarizing plates stacked to a thickness of 70 micrometers (μm) or greater, and specifically, in an embodiment, from approximately 70 μm to approximately 1 mm, is prepared and cut into a circular specimen having a diameter of 8 millimeters (mm). Next, frequency sweep testing may be performed on the specimen at 85° C. by oscillation at an angular velocity from 10⁻³ rad/s to 10² rad/s, for example, using an MCR-501 (manufactured by Physica Co., Ltd.), thereby measuring a minimum value of storage modulus (G′). For measuring storage modulus of the adhesive, the adhesive may be allowed to cure at 35° C. and 45% RH for 3 days, without being limited thereto.

The polarizing plate according to an embodiment includes the polarizer 1 and the protective film 2, 3, 3a, and/or 3b on at least one surface of the polarizer 1. The protective film 2, 3, 3a, and/or 3b may be made from a cellulose film, such as triacetyl cellulose (TAC) or diacetyl cellulose. Cellulose film has a high water vapor transmission rate. As a result, even though the polarizing plate may be exposed to a high temperature for a long time, a residual volatile organic compound in the adhesive may be readily discharged to the outside of the polarizing plate, and the polarizing plate according to this embodiment may not form micro-bubbles, have a poor external appearance, and/or deterioration in durability.

To optimize optical properties, and reduce manufacturing costs, alternate films may also be used as the protective films 2, 3, 3a, and/or 3b for polarizing plates. However, these alternate films often have an extremely low water vapor transmission rate ranging from about 0.3 g/m²/day to 3 g/m²/day as compared with that of cellulose film. Thus, in embodiments with the polarizing plate having protective film 2, 3, 3a, and/or 3b with a lower water vapor transmission rate, when the polarizing plate is exposed to higher temperatures for a long period of time, the residual volatile organic compound in the adhesive may not be discharged to an outside of the polarizing plate, and, thus, the polarizing plate can suffer from generation of bubbles in the polarizing plate surface, deterioration of its durability, and/or a poor external appearance. As used herein, the term “water vapor transmission rate” may correspond to permeability to a “volatile organic compound”.

According to an embodiment of the invention, the adhesive may be used for bonding a protective film 2, 3, 3a, and/or 3b having a water vapor transmission rate (WVTR) of 100 g/m²/day or less. Even though the adhesive in these embodiments is applied to a protective film 2, 3, 3a, and/or 3b having a low water vapor transmission rate, the polarizing plate does not form micro-bubbles and can exhibit excellent durability even when exposed to high temperatures, according to these embodiments.

According to an embodiment of the invention, the adhesive may be used for bonding a protective film 2, 3, 3a, and/or 3b having a water vapor transmission rate of 100 g/m²/day or less to a liquid crystal display panel. The protective film 2, 3, 3a, and/or 3b, to which the adhesive according to an embodiment of the invention can be bonded, may have a water vapor transmission rate of 100 g/m²·day or less at 40° C. and 90% RH. Preferably, the protective film 2, 3, 3a, and/or 3b according to an emobidment has a water vapor transmission rate ranging from approximately 0.5 g/m²/day to approximately 70 g/m²/day, and more preferably ranging from approximately 2 g/m²/day to approximately 60 g/m²/day.

The protective film 2, 3, 3a, and/or 3b may include cyclic polyolefins including amorphous cyclic olefin polymers (COPs), poly(meth)acrylates including polymethyl methacrylate (PMMA), polycarbonates (PC), polyesters including polyethylene terephthalate (PET), polyethersulfones, polysulfones, polyamides, polyimides, polyolefins, polyarylates, polyvinyl alcohols, polyvinyl chlorides, polyvinylidene chlorides, and mixtures thereof.

In an embodiment, the protective film 2, 3, 3a, and/or 3b includes cyclic polyolefins, polycarbonates, poly(meth)acrylates, and/or polyesters.

The protective film 2, 3, 3a, and/or 3b according to an embodiment has a thickness ranging from 1 μm to 200 μm, and in an embodiment, from 3 μm to 80 μm, without being limited thereto.

The adhesive may include a (meth)acrylic copolymer, a curing agent, and a silane coupling agent, according to an embodiment.

The (meth)acrylic copolymer may have an average molecular weight of about 800,000 g/mol or greater. If the average molecular weight of the (meth)acrylic copolymer is less than 800,000 g/mol, an adhesive layer 4 and or 5 (for example, as shown in FIGS. 1-3) may have a high storage modulus and the polarizing plate prepared by bonding a protective film 2, 3, 3a, and/or 3b having a water vapor transmission rate of 100 g/m²/day or less can suffer from micro-bubbles when exposed to a high temperature, and thus exhibit a poor external appearance and deterioration in durability. In an embodiment, the (meth)acrylic copolymer has an average molecular weight ranging from approximately 800,000 g/mol to approximately 1,800,000 g/mol, or in an embodiment, ranging from approximately 900,000 glmol to approximately 1,600,000 g/mol, for example approximately 800,000, 900,000, 1,000,000, 1,100,000, 1,200,000, 1,300,000, 1,400,000, 1,500,000, or 1,600,000 g/mol.

The (meth)acrylic copolymer according to an embodiment may have a glass transition temperature of less than −29° C. Within this range, when the adhesive is coated onto the protective film 2, 3, 3a, and/or 3b having a water vapor transmission rate of 100 g/m²/day or less, the polarizing plate does not suffer from micro-bubbles and can exhibit excellent durability even though the polarizing plate is exposed to high temperatures. In an embodiment, the (meth)acrylic copolymer has a glass transition temperature ranging from approximately −40° C. to approximately −30° C., and in another embodiment, from approximately −38° C. to approximately −31° C., for example approximately −40, −39, −38, −37, −36, −35, −34, −33, −32, −31, or −30° C.

The (meth)acrylic copolymer according to these embodiments may be a copolymer of a mixture comprising at least two of a hydroxyl group-containing (meth)acrylic monomer, an alkyl group-containing (meth)acrylic monomer, and a carboxylic acid group-containing (meth)acrylic monomer. For example, the (meth)acrylic copolymer may be a copolymer of a monomer mixture comprising a hydroxyl group-containing (meth)acrylic monomer, an alkyl group-containing (meth)acrylic monomer, and a carboxylic acid group-containing (meth)acrylic monomer.

The hydroxyl group-containing (meth)acrylic monomer according to an embodiment may be a (meth)acrylic acid ester containing a C₂ to C₂₀ alkyl group having at least one hydroxyl group at a terminal or in the molecular structure thereof. For example, the hydroxyl group-containing (meth)acrylic monomer may include at least one selected from among 2-hydroxyethyl (meth)acrylate, 2-hydroxypropyl (meth)acrylate, 2-hydroxybutyl (meth)acrylate, 4-hydroxybutyl (meth)acrylate, 6-hydroxyhexyl (meth)acrylate, 1,4-cyclohexanedimethanol mono(meth)acrylate, 1-chloro-2-hydroxypropyl (meth)acrylate, diethyleneglycol mono(meth)acrylate, 1,6-hexanediol mono(meth)acrylate, pentaerythritol tri(meth)acrylate, dipentaerythritol penta(meth)acrylate, neopentylglycol mono(meth)acrylate, trimethylolpropane di(meth)acrylate, trimethylolethane di(meth)acrylate, 2-hydroxy-3-phenyloxypropyl (meth)acrylate, 4-hydroxycyclopentyl (meth)acrylate, 4-hydroxycyclohexyl (meth)acrylate, and cyclohexanedimethanol mono(meth)acrylate, without being limited thereto.

The hydroxyl group-containing (meth)acrylic monomer according to an embodiment may be present in an amount ranging from approximately 0.1% by weight (wt %) to approximately 10 wt %, and in an embodiment, from approximately 0.5 wt % to approximately 2 wt %, for example 0.5, 0.6, 0.7, 0.8, 0.9, 1.0, 1.1, 1.2, 1.3, 1.4, 1.5, 1.6, 1.7, 1.8, 1.9, or 2 wt % in a monomer mixture for the (meth)acrylic copolymer. Within this range, the adhesive according to embodiments of the present invention can exhibit improved adhesion.

The alkyl group-containing (meth)acrylic monomer according to an embodiment may include a (meth)acrylic acid ester containing a linear or branched, unsubstituted C₁ to O₂₀ alkyl group. For example, the alkyl group-containing (meth)acrylic monomer may include at least one selected from among methyl (meth)acrylate, ethyl (meth)acrylate, propyl (meth)acrylate, n-butyl (meth)acrylate, t-butyl (meth)acrylate, iso-butyl (meth)acrylate, pentyl (meth)acrylate, hexyl (meth)acrylate, 2-ethylhexyl (meth)acrylate, heptyl (meth)acrylate, octyl (meth)acrylate, iso-octyl (meth)acrylate, nonyl (meth)acrylate, decyl (meth)acrylate, and lauryl (meth)acrylate, without being limited thereto.

The alkyl group-containing (meth)acrylic monomer according to an embodiment may be present in an amount of ranging from approximately 84 wt % to approximately 99.9 wt %, and in an embodiment, ranging from approximately 84 wt % to approximately 99.8 wt %, and in another embodiment, from approximately 85 wt % to approximately 95 wt %, for example approximately 84, 85, 86, 87, 88, 89, 90, 91, 92, 93, 94, or 95 wt % in the monomer mixture for the (meth)acrylic copolymer.

The carboxylic acid group-containing vinyl monomer may include (meth)acrylic acid and f3-carboxyethyl (meth)acrylate, without being limited thereto.

The carboxylic acid group-containing (meth)acrylic monomer according to an embodiment may be present in an amount ranging from approximately 0 to approximately 6 wt %, and in an embodiment from approximately 0.1 wt % to approximately 6 wt %, and in another embodiment, from approximately 1 wt % to about 4 wt %, for example approximately 0.1, 1, 2, 3, 4, 5, or 6 wt % in the monomer mixture for the (meth)acrylic copolymer. Within this range, the adhesive according to these embodiments can exhibit improved adhesion.

The (meth)acrylic copolymer according to an embodiment may be further polymerized with an aromatic ring-containing vinyl monomer, an alicyclic ring-containing vinyl monomer, a pyrrolidonyl group-containing vinyl monomer, an N-substituted maleimide, a furyl group-containing monomer, or mixtures thereof.

The aromatic ring-containing vinyl monomer according to an embodiment may be a vinyl monomer having positive birefringence.

In one embodiment, the aromatic ring-containing vinyl monomer may be a vinyl monomer represented by Formula 1, below:

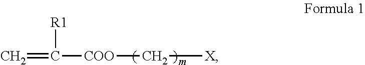

wherein R1 is hydrogen or a C₁ to C₅ alkyl group; m is an integer ranging from 0 to 10; and X is selected from the group consisting of phenyl, methylphenyl, methylethylphenyl, methoxyphenyl, propylphenyl, cyclohexylphenyl, chlorophenyl, bromophenyl, phenylphenyl, and benzylphenyl groups.

In another embodiment, the aromatic ring-containing vinyl monomer may be a vinyl monomer represented by Formula 2, below:

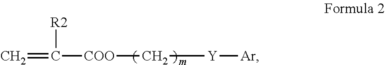

wherein R2 is hydrogen or a C₁ to C₅ alkyl group; m is an integer ranging from 0 to 10; Y is oxygen or sulfur; and Ar is selected from the group consisting of phenyl, methylphenyl, methylethylphenyl, methoxyphenyl, propylphenyl, cyclohexylphenyl, chlorophenyl, bromophenyl, phenylphenyl, and benzylphenyl groups.

Specifically, the vinyl monomer represented by Formula 1 or 2 according to embodiments of the present invention may include at least one selected from among phenoxy (meth)acrylate, 2-ethylphenoxy (meth)acrylate, benzyl (meth)acrylate, phenyl (meth)acrylate, 2-ethylthiophenyl (meth)acrylate, 2-phenylethyl (meth)acrylate, 3-phenylpropyl (meth)acrylate, 4-phenylbutyl (meth)acrylate, 2-(2-methylphenyl)ethyl (meth)acrylate, 2-(3-methylphenyl)ethyl (meth)acrylate, 2-(4-methylphenyl)ethyl (meth)acrylate, 2-(4-propylphenyl)ethyl (meth)acrylate, 2-(4-(1-methylethyl)phenyl)ethyl (meth)acrylate, 2-(4-methoxyphenyl)ethyl (meth)acrylate, 2-(4-cyclohexylphenyl)ethyl (meth)acrylate, 2-(2-chlorophenyl)ethyl (meth)acrylate, 2-(3-chlorophenyl)ethyl (meth)acrylate, 2-(4-chlorophenyl)ethyl (meth)acrylate, 2-(4-bromophenyl)ethyl (meth)acrylate, 2-(3-phenylphenyl)ethyl methacrylate, and 2-(4-benzylphenyl)ethyl methacrylate, without being limited thereto.

In another embodiment, the aromatic ring-containing vinyl monomer may include at least one selected from among phenoxydiethylene glycol (meth)acrylate, ethylene oxide-modified nonylphenol (meth)acrylate, biphenyl (meth)acrylate, styrene, vinyl toluene, alpha-methylstyrene, and hydroxyethylated beta-naphthol (meth)acrylate.

The alicyclic ring-containing vinyl monomer according to an embodiment may include at least one of a (meth)acrylic acid ester having a C₄ to C₂₀ mono- or poly-alicyclic ring. For example, alicyclic ring-containing vinyl monomer may include at least one selected from among cyclopentyl (meth)acrylate, cyclohexyl (meth)acrylate, and isobornyl (meth)acrylate, without being limited thereto.

The pyrrolidonyl group-containing vinyl monomer according to an embodiment may include N-vinylpyrrolidone, without being limited thereto.

The furyl group-containing monomer according to an embodiment may include at least one selected from among a furyl group containing vinyl monomers including furyl (meth)acrylate or tetrahydroperfuryl (meth)acrylate, furyl isocyanate, furyl propionate, and furyl pentanoate, without being limited thereto.

The N-substituted maleimide according to an embodiment may be a maleimide, in which N is substituted by a C₁ to C₅ alkyl group, a C₆ to C₁₀ aryl group, or a C₅ to C₁₀ cycloalkyl group.

In an embodiment aromatic ring-containing vinyl monomer, the alicyclic ring-containing vinyl monomer, the pyrrolidonyl group-containing vinyl monomer, the N-substituted maleimide, the furyl group-containing monomer, or a mixture thereof may be optionally present in an amount of 30 wt % or less, and in an embodiment, ranging from approximately 0.1 wt % to approximately 14 wt %, in the mixture for the (meth)acrylic copolymer.

The (meth)acrylic copolymer according to an embodiment may be prepared by any typical preparation method. For example, an initiator may be added to the mixture of the monomers for polymerization. The initiator may include at least one selected from among 2,2-azobis(2,4-dimethylvaleronitrile), azobisisobutyronitrile, benzoyl peroxide, dilauroyl peroxide, tert-butyl-(2-ethylhexyl)monoperoxycarbonate, tert-amyl-(2-ethylhexyl)monoperoxycarbonate, 1,1-di(tert-butylperoxy)cyclohexane, 1,1-di(tert-amylperoxy)cyclohexane, tert-butyl peroxy-3,5,5-trimethylhexanoate, 1,1-di(tert-butyl peroxy)-3,3,5-trimethylcyclohexane, potassium persulfate, sodium persulfate, ammonium persulfate, and azo-based water soluble initiators, without being limited thereto. The initiator may be present in an amount ranging from approximately 0.001 parts by weight to approximately 2 parts by weight based on 100 parts by weight of the alkyl group-containing (meth)acrylic monomer.

The copolymer according to an embodiment may be prepared by any typical polymerization, for example, suspension polymerization, emulsion polymerization, and the like, without being limited thereto. Temperature and time for polymerization may be suitably adjusted as appreciated by those skilled in the art.

The curing agent may be present in an amount ranging from approximately 0.5 parts by weight to approximately 5 parts by weight, for example approximately 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0 parts by weight based on 100 parts by weight of the (meth)acrylic copolymer. Within this range, since the adhesive layer 4 or 5 has a high storage modulus, the polarizing plate, prepared by bonding the protective film 2, 3, 3a, and/or 3b having a water vapor transmission rate of 100 g/m²/day or less, does not suffer from deterioration in external appearance or generation of micro-bubbles when exposed to high temperatures. In addition, due to low degree of cross-linking in these embodiments, the adhesive layer 4 or 5 does not cause stress when applied as the protective film 2, 3, 3a, and/or 3b of the polarizing plate. In an embodiment, the curing agent may be present in an amount ranging from approximately 0.6 parts by weight to approximately 4.7 parts by weight.

The curing agent according to an embodiment may be selected from the group consisting of isocyanate, carbodiimide, epoxy, aziridine, melamine, amine, imide, and amide curing agents.

In one embodiment, the curing agent may be solely an isocyanate curing agent.

In another embodiment, the curing agent may be a mixture of isocyanate and carbodiimide curing agents. The isocyanate curing agent and the carbodiimide curing agent according to this embodiment may be mixed in a weight ratio (isocyanate curing agent: carbodiimide curing agent) ranging from approximately 2:1 to approximately 30:1, for example approximately 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, 20:1, 21:1, 22:1, 23:1, 24:1, 25:1, 26:1, 27:1, 28:1, 29:1, or 30:1.

In one embodiment, the mixture may include a range from approximately 65 wt % to approximately 95 wt %, for example approximately 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95 wt % of the isocyanate curing agent, and from approximately 5 wt % to approximately 35 wt %, for example, approximately 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, or 35 wt % of the carbodiimide curing agent.

A typical isocyanate curing agent known to those skilled in the art may be used as the curing agent in an embodiment. For example, the isocyanate curing agent may include at least one selected from the group consisting of 2,4-toluene diisocyanate, 2,6-toluene diisocyanate, hydrogenated toluene diisocyanate, 1,3-xylene diisocyanate, 1,4-xylene diisocyanate, diphenylmethane-4,4′-diisocyanate, 1,3-bisisocyanatomethyl cyclohexane, tetramethylxylene diisocyanate, 1,5-naphthalene diisocyanate, 2,2,4-trimethylhexamethylene diisocyanate, 2,4,4-trimethylhexamethylene diisocyanate, an adduct of tolylene diisocyanate with trimethylolpropane, an adduct of xylene diisocyanate with trimethylolpropane, triphenylmethanetriisocyanate, and methylenebistriisocyanate.

Any typical carbodiimide curing agent known to those skilled in the art may be used as the curing agent according to embodiments of the present invention. For example, although any carbodiimide curing agent can be used so long as the carbodiimide curing agent includes —(—N═C═N—)—, the carbodiimide curing agent may be a carbodiimide curing agent including a unit having the following structures:

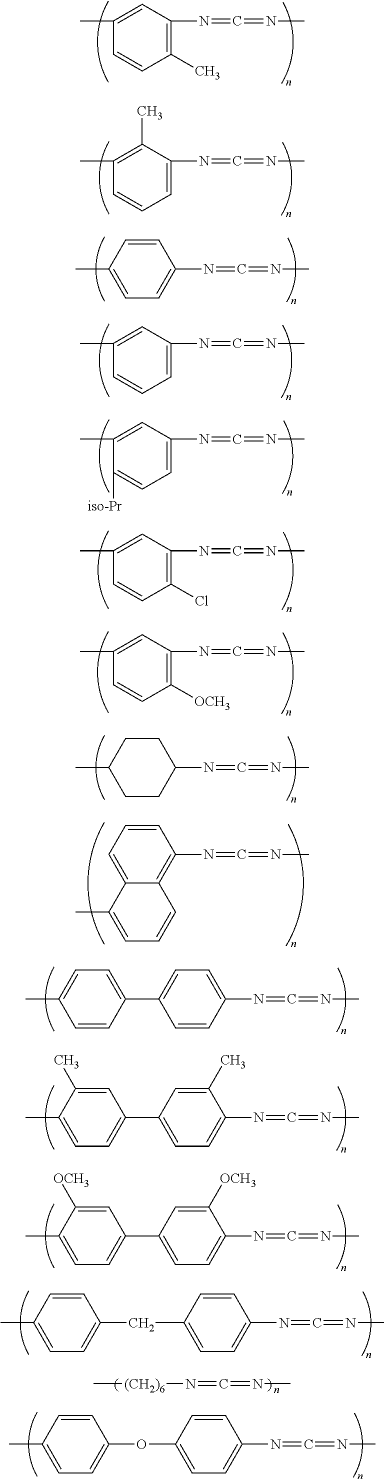

wherein n is an integer ranging from 5 to 100.

The carbodiimide curing agent according to these embodiments may have an average molecular weight ranging from approximately 1,000 g/mol to approximately 5,000 g/mol, for example 1000, 2000, 3000, 4000, or 5000 g/mol. Within this range, the curing agent can provide appropriate reaction speed, thereby providing good stability of a preparation solution and good curing reaction with the copolymer.

The silane coupling agent according to an embodiment may be present in an amount ranging from approximately 0.01 parts by weight to approximately 5 parts by weight based on 100 parts by weight of the (meth)acrylic copolymer. Within this range, the adhesive according to these embodiments, can exhibit excellent adhesion to a liquid crystal panel, and the (meth)acrylic copolymer can exhibit excellent storage stability. The silane coupling agent according to an embodiment, may be present in an amount ranging from approximately 0.01 parts by weight to approximately 1 part by weight, and in another embodiment, from approximately 0.01 parts by weight to approximately 0.5 parts by weight.

Any silane coupling agent known in the art may be used, according to embodiments of the present invention. For example, the silane coupling agent may include at least one selected from the group consisting of silicon compounds having an epoxy moiety, such as 3-glycidoxypropyltrimethoxysilane, 3-glycidoxypropylmethyldimethoxysilane, 2-(3,4-epoxycyclohexyl)ethyltrimethoxysilane; polymerizable unsaturated group-containing silicon compounds, such as vinyltrimethoxysilane, vinyltriethoxysilane, (meth)acryloxypropyltrimethoxysilane; amino group-containing silicon compounds, such as 3-aminopropyltrimethoxysilane, N-(2-aminoethyl)-3-aminopropyltrimethoxysilane, N-(2-aminoethyl)-3-aminopropylmethyldimethoxysilane; and 3-chloropropyltrimethoxysilane, without being limited thereto. In an embodiment, a silane coupling agent having an epoxy structure is used.

The adhesive for polarizing plates according to an embodiment may further include a solvent. The solvent may include methylethylketone, without being limited thereto.

According to another embodiment of the present invention, a polarizing plate may include an adhesive layer 4 or 5 formed of the adhesive composition for polarizing plates described above.

Specifically, the polarizing plate according to an embodiment may include the adhesive layer 4 or 5 and a protective film 2, 3, 3a, and/or 3b which has a water vapor transmission rate of about 100 g/m²/day or less at 40° C. and 90% RH.

Details of the protective film 2, 3, 3a, and/or 3b having a water vapor transmission rate of about 100 g/m²/day or less at 40° C. and 90% RH, according to this embodiment, are the same as those embodiments described above. The protective film 2, 3, 3a, and/or 3b may be stacked on a liquid crystal display panel via the adhesive layer 4 or 6.

In addition, the adhesive layer 4 of 5, in an embodiment, may bond protective films 2, 3, 3a, and/or 3b, each having a water vapor transmission rate of about 100 g/m²/day or less at 40° C. and 90% RH, to each other.

Further, in an embodiment, the adhesive layer 4 or 5 may bond a protective film 2, 3, 3a, and/or 3b having a water vapor transmission rate of approximately 100 g/m²/day or less at 40° C. and 90% RH to a protective film 2, 3, 3a, and/or 3b having a water vapor transmission rate of greater than about 100 g/m²/day at 40° C. and 90% RH.

The adhesive layer 4 or 5 according to an embodiment may be formed by drying the adhesive for polarizing plates.

The adhesive layer 4 or 5 according to an embodiment may have a thickness ranging from approximately 5 μm to approximately 100 μm after drying. Drying according to this embodiment may be performed at 90° C. for 4 minutes, without being limited thereto.

The polarizing plate according to an embodiment includes a polarizer 1 and protective films 2, 3, 3a, and/or 3b stacked on both sides of the polarizer 1.

The polarizer 1 according to an embodiment includes a polyvinyl alcohol film, and may be any polyvinyl alcohol film without limitation regardless of a preparation method. For example, the polarizer 1 may be a modified polyvinyl alcohol film, such as partially formalized polyvinyl alcohol films, acetoacetyl group-modified polyvinyl alcohol films, etc.

The polyvinyl alcohol film according to an embodiment may have a degree of polymerization ranging from approximately 1,500 to approximately 4,000. Within this range, the film according to these embodiments can act as a polarization substrate and can exhibit optical properties when prepared as a polarizing film.

The polarizer 1 according to an embodiment may be prepared by dyeing a polyvinyl alcohol film with iodine or a dichroic dye, followed by stretching the polyvinyl alcohol film in a certain direction. Specifically, the polarizer 1 according to an embodiment is prepared through swelling, dyeing, and stretching. Each process may be performed by a method generally known in the art.

The polarizer 1 according to an embodiment may have a thickness ranging from approximately 10 μm to approximately 50 μm, without being limited thereto.

Details of the protective film 2, 3, 3a, and/or 3b according to these embodiments are the same as those described above.

The protective film 2, 3, 3a, and/or 3b according to an embodiment may have a thickness ranging from approximately 10 μm to approximately 200 μm, and in an embodiment, from according to an embodiment 30 μm to according to an embodiment 120 μm, without being limited thereto.

FIG. 1 is a sectional view of a polarizing plate according to one embodiment of the present invention.

Referring to the embodiment shown in FIG. 1, a polarizing plate may include a polarizer 1, a first protective film 2 on an upper surface of the polarizer 1, and a second protective film 3 on a lower surface of the polarizer 1 to be placed on a liquid crystal display panel.

The second protective film 3 may have a water vapor transmission rate of approximately 100 g/m²/day or less at 40° C. and 90% RH, and may be positioned on the liquid crystal display panel via an adhesive layer 4. The adhesive layer 4 may be formed of the adhesive for polarizing plates described above.

FIG. 2 is a sectional view of a polarizing plate according to another embodiment of the present invention.

Referring to the embodiment shown in FIG. 2, a polarizing plate may include a polarizer 1, a first protective film 2 on an upper surface of the polarizer 1, a second protective film 3a on a lower surface of the polarizer 1, and a third protective film 3b on a lower surface of the second protective film 3a to be placed on a liquid crystal display panel.

At least one of the second and third protective films 3a or 3b according to this embodiment may have a water vapor transmission rate of approximately 100 g/m²/day or less at 40° C. and 90% RH. The third protective film 3b may be positioned between the second protective film 3a and the liquid crystal display panel via adhesive layers 4 and/or 5. At least one of the adhesive layers 4 and/or 5 may be formed of the adhesive for polarizing plates described above.

FIG. 3 is a sectional view of a polarizing plate according to another embodiment of the present invention.

Referring to the embodiment shown in FIG. 3, a polarizing plate may include a polarizer 1, a first protective film 2 on an upper surface of the polarizer 1, a second protective film 3a on a lower surface of the polarizer 1, and a third protective film 3b on an upper surface of the first protective film 2. The third protective film 3b according to this embodiment may be bonded to the first protective film 2 via an adhesive layer 4, and the second protective film 3a may be bonded to a liquid crystal display panel via an adhesive layer 5. At least one of the adhesive layers 4 and/or 5 according to this embodiment may be formed of the adhesive for polarizing plates described above. At least one of the first, second, and third protective films 2, 3a, and/or 3b, according to this embodiment, may have a water vapor transmission rate of approximately 100 g/m²/day or less at 40° C. and 90% RH.

According to an embodiment, in FIGS. 1 through 3, at least one of the first, second, and third protective films 2, 3a, and/or 3b may be replaced by a retardation film. The retardation film may be a typical retardation film known in the art. For example, the retardation film may be selected from among cyclic polyolefin, polycarbonate, poly(meth)acrylate, and polyester films.

In accordance with a further embodiment of the present invention, a liquid crystal display may include the polarizing plate.

Specifically, the liquid crystal display according to an embodiment may include either a front polarizing plate placed on a front side of a liquid crystal display panel, or a rear polarizing plate placed on rear side of the liquid crystal display panel, between a backlight unit and the liquid crystal display panel, or include both front and rear polarizing plates.

Hereinafter, embodiments of the present invention will be described in more detail with reference to some examples. However, it should be noted that these examples are provided for illustration only and are not to be construed in any way as limiting the present invention.

Details of components used in EXAMPLES and COMPARATIVE EXAMPLES were as follows:

(A) (Meth)acrylic copolymer

(A1) CI-203 (Soken Co., Ltd., Mw: 1,600,000 g/mol, Tg: −33° C.);

(B) Curing agent

(B1) Isocyanate curing agent: Trimethylolpropane adduct of diisocyanate Coronate L (Nippon Polyurethane Industry, Japan);

(B2) Carbodiimide curing agent: VO5S (Nisshinbo Chemical Co., Ltd.)

(C) Silane coupling agent: 3-glycidoxypropyltrimethoxysilane KBM-403 (Shin-Etsu Chemical Co., Ltd.).

### Example 1

100 parts by weight of the (A1) (meth)acrylic copolymer, 0.5 parts by weight of the (B1) curing agent, and 0.16 parts by weight of the (B2) curing agent were introduced into 20 parts by weight of methylethylketone, followed by stirring at 25° C. for 5 minutes. The silane coupling agent at 0.35 parts by weight was added to the mixture, followed by stirring at 25° C. for 5 minutes, thereby preparing an adhesive for polarizing plates.

### Examples 2, 3, and 4 and Comparative Example 1

Adhesives for polarizing plates were prepared in the same manner as in EXAMPLE 1 except that the curing agents were added in amounts as listed in TABLE 1 (unit: parts by weight in terms of solid content). Minimum storage modulus of an adhesive layer was measured on each of the prepared adhesives by the following method.

TABLE 1

| | | | | | | COMPARA- |
|---|---|---|---|---|---|---|
| | | | | | | TIVE |
| | | EXAMPLE | | | | EXAMPLE |
| | | 1 | 2 | 3 | 4 | 1 |
| (A): (A1) | | 100 | 100 | 100 | 100 | 100 |
| (B) | (B1) | 0.50 | 0.81 | 1.26 | 1.87 | 0.28 |
| | (B2) | 0.16 | 0.16 | 0.16 | 0.16 | 0.16 |

| | | | | | |
|---|---|---|---|---|---|
| (C) | 0.35 | 0.35 | 0.35 | 0.35 | 0.35 |
| Minimum storage | 8 | 12 | 15 | 26 | 6 |
| modulus of adhesive | | | | | |
| layer (×10³ Pa) | | | | | |

### Experimental Example

Property evaluation of adhesive for polarizing plate. The adhesives for polarizing plates prepared in EXAMPLES 1-4 and the COMPARATIVE EXAMPLE 1 were evaluated as to the following properties. Results are shown in TABLES 2 and 3.

Method of Property Evaluation

(1) Storage modulus (Pa): Each of the prepared adhesives for polarizing plates was coated onto a polyethylene terephthalate release film, followed by drying at 90° C. for 4 minutes, thereby preparing an adhesive sheet having a 20 μm thick adhesive layer. The adhesive layer was cured at 35° C. and 45% RH for 3 days. Several cured adhesive layers were stacked one above another to form a 1 mm thick adhesive sheet, which was then cut into a circular specimen having a diameter of 8 mm. Storage modulus of the specimen was measured using a storage modulus tester, for example MCR-501 (Physical Company Ltd.), through frequency sweep testing at 85° C. and a frequency of about 10⁻³rad/s to about 10² rad/s. A minimum storage modulus was obtained.

(2) Micro-bubbles at high temperature: While being moved on a guide roll, the polyvinyl alcohol film was dyed by dipping in a dyeing solution of iodine and potassium iodide, followed by stretching to a length of 3 times an initial length of the polyvinyl alcohol film. Next, the film was introduced into a tank containing boric acid and potassium iodide to be cross-linked, followed by treatment at 80° C. for 5 minutes to 8 minutes, thereby preparing the polarizer.

The protective films were bonded to the prepared polarizer in combinations according to TABLES 2 and 3, thereby preparing the polarizing plates as shown in the embodiments of FIGS. 1 through 3.

TAC films (KC4UYW, KONICA Co., Ltd., water vapor transmission rate at 40° C. and 90% RH: 400 g/m²/day, thickness: 40 μm), PMMA films (OXIS-X, Zeon CO., Ltd., water vapor transmission rate at 40° C. and 90% RH: 60 g/m²/day, thickness: 40 μm), PC films (WRS, TEIJIN Co., Ltd., water vapor transmission rate at 40° C. and 90% RH: 25 g/m²/day, thickness: 40 μm), and COP films (ZEONOR, Zeon CO., Ltd., water vapor transmission rate at 40° C. and 90% RH: 2 g/m²/day, thickness: 30 μm) were used as the protective films.

Water vapor transmission rate of each of the protective films was measured by the following method. The protective films were each cut into a circular sample having a diameter of 10 cm. Then, 3 g of CaCl₂ was placed on a glass plate, and the glass plate was placed in a water vapor permeable cup. The circular sample was placed in the cup, and the sample was positioned at a center position using a ring. After placing a weight on the ring and then removing a guide, a gap between the ring and the cup was filled with paraffin subjected to heating in boiling water so as to be sealed. After the paraffin was cured, the weight was removed, and the weight of the water vapor permeable cup was measured. The water vapor permeable cup was placed in a thermohygrostat at 40° C. and 90% RH, and removed from the thermohygrostat after 24 hours, and weighed again. A water vapor permeable area, as used herein, means an overall surface area of the cup. Water vapor transmission rate was calculated by the following Equation, and the number of specimens per sample was 2 to 3.

$$Water vapor transmission rate ( g \text{/} {m}^{2} \cdot day ) = \frac{\begin{matrix}Weight of specimen after 24 hours ( g ) - \\ Initial weight of specimen ( g )\end{matrix}}{Water vapor permeable area of cup ( {m}^{2} )}$$

In the polarizing plate in the embodiment shown in FIG. 1, a TAC film was used as the first protective film, and protective films according to TABLES 2 and 3 were used as the second protective film 3.

In the polarizing plate in the embodiment shown in FIG. 2, a TAC film was used as the first protective film 2, and protective films according to TABLES 2 and 3 were used as the second and third protective films 3a and 3b, respectively.

In the polarizing plate in the embodiment shown in FIG. 3, protective films according to TABLES 2 and 3 were used as the first and third protective films 2 and 3b, and a PC film was used as the second protective film 3a.

The prepared polarizing plate was cut into a specimen having a size of 10 cm×8 cm. The specimen was attached to a liquid crystal display or a glass plate, and pressed at 50° C. and 3.5 atm pressure. The liquid crystal display or glass plate, to which the polarizing plate specimen was attached, was exposed at 85° C. for 250 hours, and then exposed at 25° C. for at least one hour. Whether bubbling was generated inside the polarizing plate was observed by the naked eye or by an optical microscope. In the tables, an X denotes that no bubbling was detected, and an O denotes the appearance of bubbling.

TABLE 2

| | | EXAMPLE | | | | | | | | |
|---|---|---|---|---|---|---|---|---|---|---|
| | | 5 | 6 | 7 | 8 | 9 | 10 | 11 | 12 | 13 |
| Structure of | | FIG. 1 | FIG. 1 | FIG. 2 | FIG. 2 | FIG. 2 | FIG. 3 | FIG. 3 | FIG. 3 | FIG. 3 |
| polarizing plate | | | | | | | | | | |
| Protective | Material | PMMA | COP | PMMA | PC | COP | TAC | PMMA | PC | COP |
| film | Water | 60 | 2 | 60 | 25 | 2 | 400 | 60 | 25 | 2 |
| (3 of FIG. | vapor | | | | | | | | | |
| 1, 3a of | transmission | | | | | | | | | |
| FIG. 2, 2 | rate | | | | | | | | | |
| of FIG. 3) | (g/m² · day) | | | | | | | | | |
| Protective | Material | — | — | PMMA | PC | COP | PMMA | PC | COP | COP |
| film | Water | — | — | 60 | 25 | 2 | 60 | 25 | 2 | 2 |
| (3b of | vapor | | | | | | | | | |
| FIG. 2, 3b | transmission | | | | | | | | | |
| of FIG. 3) | (g/m² · day) | | | | | | | | | |

| | | | | | | | | | |
|---|---|---|---|---|---|---|---|---|---|
| Adhesive layer | EXAM- | EXAM- | EXAM- | EXAM- | EXAM- | EXAM- | EXAM- | EXAM- | EXAM- |
| | PLE 1 | PLE 4 | PLE 1 | PLE 2 | PLE 3 | PLE 2 | PLE 4 | PLE 4 | PLE 4 |
| Minimum storage | 8 | 26 | 8 | 12 | 15 | 12 | 26 | 26 | 26 |
| modulus of adhesive | | | | | | | | | |
| layer | | | | | | | | | |
| (×10³ Pa) | | | | | | | | | |
| Micro-bubbles at | X | X | X | X | X | X | X | X | X |
| high temperature | | | | | | | | | |

TABLE 3

| | | COMPARATIVE EXAMPLE | | |
|---|---|---|---|---|
| | | 2 | 3 | 4 |
| Structure of polarizing plate | | FIG. 2 | FIG. 3 | FIG. 3 |
| Protective | Material | PC | TAC | TAC |
| film | | | | |
| (3a of FIG. | | | | |
| 2, or 1 of | | | | |
| FIG. 3) | | | | |
| | Water vapor | 25 | 400 | 400 |
| | transmission | | | |
| | rate | | | |
| | (g/m² · day) | | | |
| Protective | Material | PMMA | PMMA | COP |
| film | | | | |
| (3b of FIG. | | | | |
| 2, or 3b of | | | | |
| FIG. 3) | | | | |
| | Water vapor | 60 | 60 | 2 |
| | transmission | | | |
| | rate | | | |
| | (g/m² · day) | | | |

| | | | |
|---|---|---|---|
| Adhesive layer | COMPARA- | COMPARA- | COMPARA- |
| | TIVE | TIVE | TIVE |
| | EXAM- | EXAM- | EXAM- |
| | PLE 1 | PLE 1 | PLE 1 |
| Minimum storage | 6 | 6 | 6 |
| modulus of adhesive | | | |
| layer (×10³ Pa) | | | |
| Micro-bubbles at high | ◯ | ◯ | ◯ |
| temperature | | | |

As shown in TABLES 2 and 3, each of the polarizing plates including the adhesive layer formed of the adhesive according to the embodiments of invention did not suffer from the formation of micro-bubbles even after storage at high temperature for an extended length of time. Thus, the embodiments of the present invention provide an adhesive for polarizing plates which does not generate micro-bubbles when applied to a protective film having a low water vapor transmission rate to prepare a polarizing plate, and which secures high durability of the polarizing plate even when the polarizing plate is exposed to a high temperature for an extended period of time.

Conversely, it could be seen that the polarizing plates of COMPARATIVE EXAMPLES 2 through 4, which included the adhesive layer of COMPARATIVE EXAMPLE 1 having a storage modulus out of the range according to the embodiments of the present invention, suffered from the formation of micro-bubbles when exposed to a high temperature for an extended period of time.

What is claimed is:

1. An adhesive comprising a (meth)acrylic copolymer, a curing agent, and a silane coupling agent,
wherein the (meth)acrylic copolymer has an average molecular weight of at least 800,000 g/mol, and the adhesive has a storage modulus ranging from approximately 8,000 Pa or more to less than approximately 27,000 Pa at 85° C. and at a frequency ranging from 10⁻³ rad/s to 10² rad/s after curing, the adhesive being configured to bond a protective film of a polarizing plate having a water vapor transmission rate (WVTR) of approximately 100 g/m²/day or less at 40° C. and 90% RH.

2. The adhesive according to claim 1, wherein the adhesive is configured to bond a protective film having a water vapor transmission rate (WVTR) ranging from approximately 2 g/m²/day to approximately 60 g/m²/day.

3. The adhesive according to claim 1, wherein the protective film comprises at least one of a cyclic polyolefin, a poly(meth)acrylate, a polycarbonate, a polyester, a polyethersulfone, a polysulfone, a polyamide, a polyimide, a polyolefin, a polyarylate, a polyvinyl alcohol, a polyvinyl chloride, and a polyvinylidene chloride film.

4. The adhesive according to claim 1, wherein the (meth)acrylic copolymer has an average molecular weight ranging from approximately 800,000 g/mol to approximately 1,800,000 g/mol.

5. The adhesive according to claim 1, wherein the (meth)acrylic copolymer has a glass transition temperature ranging from approximately −40° C. to approximately −30° C.

6. The adhesive according to claim 1, wherein the (meth)acrylic copolymer comprises a copolymer of a monomer mixture comprising a hydroxyl group-containing (meth)acrylic monomer, an alkyl group-containing (meth)acrylic monomer, and a carboxylic acid group-containing (meth)acrylic monomer.

7. The adhesive according to claim 1, wherein the curing agent comprises at least one of an isocyanate, a carbodiimide, an epoxy, an aziridine, a melamine, an amine, an imide, and an amide curing agent.

8. The adhesive according to claim 1, wherein the curing agent comprises a mixture of an isocyanate curing agent and a carbodiimide curing agent, the mixture having a weight ratio of the isocyanate curing agent to the carbodiimide curing agent ranging from 2:1 to 30:1.

9. The adhesive according to claim 1, wherein the curing agent comprises approximately 0.5 parts by weight to approximately 5 parts by weight based on 100 parts by weight of the (meth)acrylic copolymer.

10. The adhesive according to claim 1, wherein the silane coupling agent comprises an epoxy moiety.

11. The adhesive according to claim 1, wherein the silane coupling agent comprises approximately 0.01 parts by weight to approximately 5 parts by weight based on 100 parts by weight of the (meth)acrylic copolymer.

12. A polarizing plate comprising:
a polarizer;
a first protective film on a top surface the polarizer;
a second protective film on a bottom surface of the polarizer; and
an adhesive layer on at least a bottom surface of the second protective film, the adhesive layer comprising a (meth)acrylic copolymer, a curing agent, and a silane coupling agent, and
wherein the (meth)acrylic copolymer has an average molecular weight of at least 800,000 g/mol, and an adhesive of the adhesive layer has a storage modulus ranging from approximately 8,000 Pa or more to less than approximately 27,000 Pa at 85° C. and at a frequency ranging from 10⁻³ rad/s to 10² rad/s after curing, the adhesive being configured to bond the protective film.

13. The polarizing plate according to claim 12, wherein the adhesive layer and the first protective film have a water vapor transmission rate (WVTR) of approximately 100 g/m²/day or less at 40° C. and 90% RH.

14. The polarizing plate according to claim 12, wherein the second protective film has a water vapor transmission rate (WVTR) of approximately 100 g/m²/day or less at 40° C. and 90% RH, and is configured to be coupled to a liquid crystal display panel via the adhesive layer.

15. The polarizing plate according to claim 12, wherein the polarizing plate further comprises a third protective film on a lower surface of the second protective film, at least one of the second and third protective films having a water vapor transmission rate of approximately 100 g/m²/day or less at 40° C. and 90% RH, the third protective film being between the second protective film and a liquid crystal display panel via the adhesive layer.

16. A liquid crystal display comprising a polarizing plate comprising:
a polarizer;
a first protective film on a top surface of the polarizer;
a second protective film on a bottom surface of the polarizer; and
an adhesive layer on at least a bottom surface of the second protective film, the adhesive layer comprising a (meth)acrylic copolymer, a curing agent, and a silane coupling agent, and
wherein the (meth)acrylic copolymer has an average molecular weight of at least 800,000 g/mol, and an adhesive of the adhesive layer has a storage modulus ranging from approximately 8,000 Pa or more to less than approximately 27,000 Pa at 85° C. and at a frequency ranging from 10⁻³ rad/s to 10² rad/s after curing, the adhesive being configured to bond the protective film.

17. The liquid crystal display according to claim 16, wherein the adhesive layer and the first protective film have a water vapor transmission rate (WVTR) of approximately 100 g/m²/day or less at 40° C. and 90% RH.

18. The liquid crystal display according to claim 16, wherein the second protective film has a water vapor transmission rate (WVTR) of approximately 100 g/m²/day or less at 40° C. and 90% RH, and is configured to be coupled to the liquid crystal display panel via the adhesive layer.

19. The liquid crystal display according to claim 16, wherein the polarizing plate further comprises a third protective film on a lower surface of the second protective film, at least one of the second and third protective films having a water vapor transmission rate (WVTR) of approximately 100 g/m²/day or less at 40° C. and 90% RH, the third protective film being between the second protective film and the liquid crystal display panel via the adhesive layer.
